(19) United States
(12) Patent Application Publication
(10) Pub. No.: US 2012/0182159 A1
(43) Pub. Date: Jul. 19, 2012

(54) Police With You (PWY)

(76) Inventor: Samad Alipour, Santa Monica, CA (US)

(21) Appl. No.: 13/352,358

(22) Filed: Jan. 18, 2012

Related U.S. Application Data
(60) Provisional application No. 61/461,465, filed on Jan. 19, 2011.

(51) Int. Cl. G08G 1/00

(52) U.S. Cl. 340/928

(57) ABSTRACT

A vehicle drivers behavior monitoring and reporting information system. This system includes a receiver that receivers information from traffic control device transmitters for traffic control devices, a processor to process information from the transmitters as well as determine traffic violations committed, a transmitter to transmit data to appropriate local authorities, an ID scanner to identify the operator of any traffic violations committed.

### PARENT CASE TEXT CROSS REFERENCE

To provisional application this application claims priority from U.S. Provisional application No. 61/461,465 filed on Jan. 19, 2011

### FIELD OF THE INVENTION

The invention relates to the field of police monitoring solutions. In particular, the invention Relates to the monitoring of conformity to vehicle traffic laws. The invention also relates to the Processing and transfer of the monitored data.

### BACKROUND OF THE INVENTION

Automobile accidental have accelerated tremendously due to drivers violating traffic laws. Traffic violations including speeding, running red lights and stop sign, and a myriad of others, these occur every day. Unfortunately police officers cannot catch every traffic violation as they occur. These automobile accidents lead to damages of personal property, public property as well as personal injuries and death. In spite of these concern the traffic violations continue to increase in number. There needs to be better way to police drivers in the effort to reduce and preferably rid our society of traffic violations.

### SUMMARY OF THE INVENTION

The invention includes a GPS unit. The GPS unit is to be installed in the dash of the vehicle. The GPS will be used to provide voice indication when a traffic violation occurs, current vehicle location information, storage of data locations of traffic control areas/devices, and serve as the interface for the operator of the vehicle. The GPS map will contain the location of but not limited to zones for speed violations, traffic control device, and parking zones. The invention installed into the dashboard shall have an ID scanner where the driver of the vehicle must slide his/her driver license and/or fingerprint to operate the vehicle. If the driver license is not valid the vehicle shall not start. The invention will use the GPS data location and traffic control device locations to determine if a traffic violation has occurred based on driving patterns of the vehicle. The invention is capable of determining direction of travel for purposes of determining if a traffic violation has occurred.

The invention will automatically monitor all traffic violations including but not limited to speeding, running stop signs, making illegal turns and illegal parking. . . . This invention shall transmit any traffic violation to the local authorities passing information including but not limited to the type of violation, location, date, time and identity of the operator of the vehicle. The invention shall be equipped with a receiver to receive data from any non static traffic control device such as traffic lights. The data received from the traffic control devices will be used to determine the status of the traffic control device and if any traffic violation has occurred.

The invention shall have an individual serial number that shall be called the S-number. At the time of installation into a vehicle, the S-number shall be recorded by the DMV. The S-number will shall serve as an identifier for the device and therefore the vehicle it is installed in. The DMV can then pull out all information of the vehicle and its owner from the S-number.

### BREIF DESCRIPTION OF THE DRAWINGS

Drawing page 1/3

FIG. 1) Transformer.

FIG. 2) Scanner.

FIG. 3) GPS.

FIG. 4) Traffic sign.

FIG. 5) Transformer on traffic sign.

FIG. 6) GPS unit with the ID card scanner attached.

FIG. 7) Showing representation of the connection between a traffic control device, the invention and a government authority.

Drawing page 2/3

FIG. 8) Showing a block diagram of the different parts of the invention and the external agencies In which it will communicate.

Drawing page 3/3

FIG. 9) Showing a GPS with including requirement additional units/parts for invention.

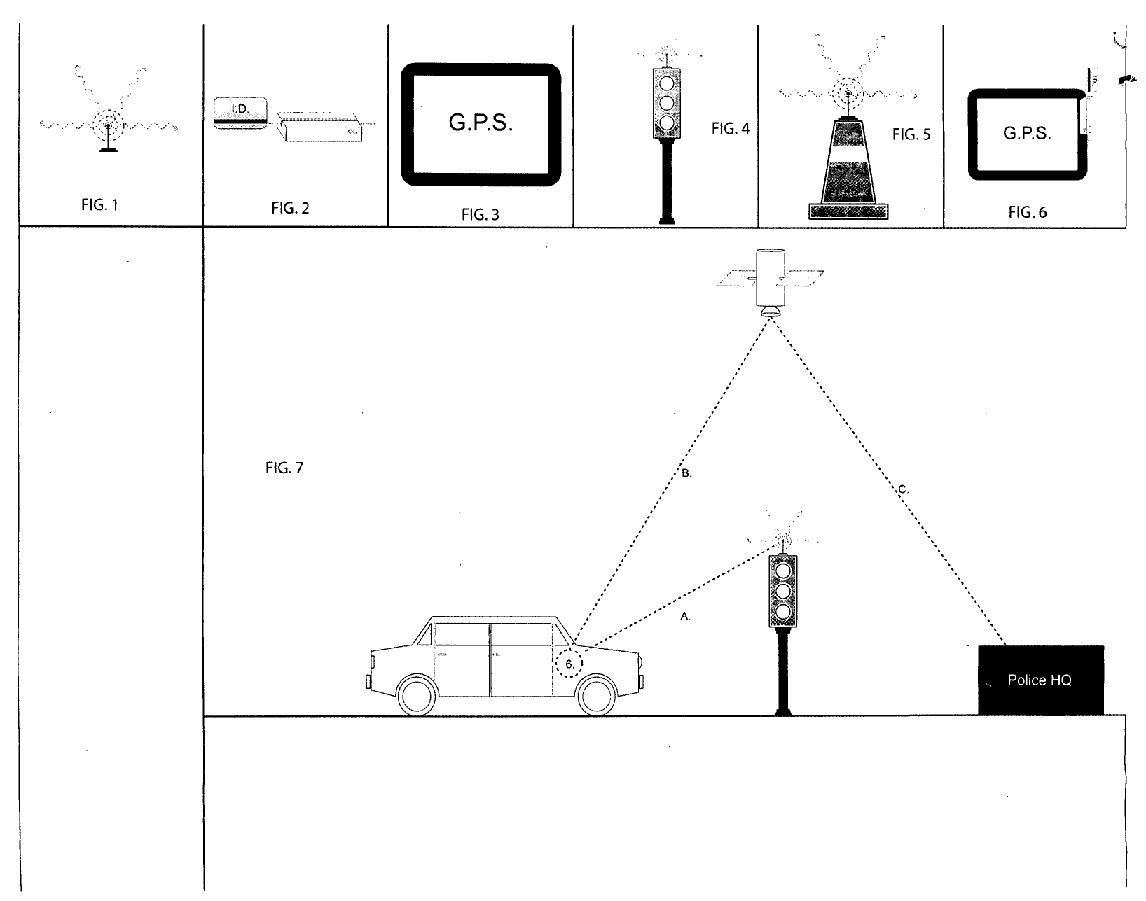

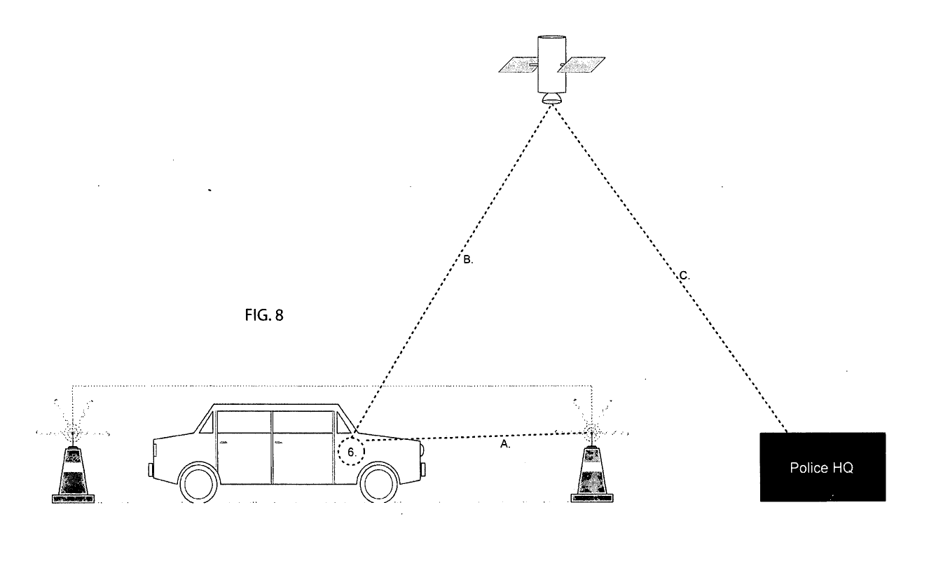

### DETAILED DESCRIPTION OF THE INVENTION

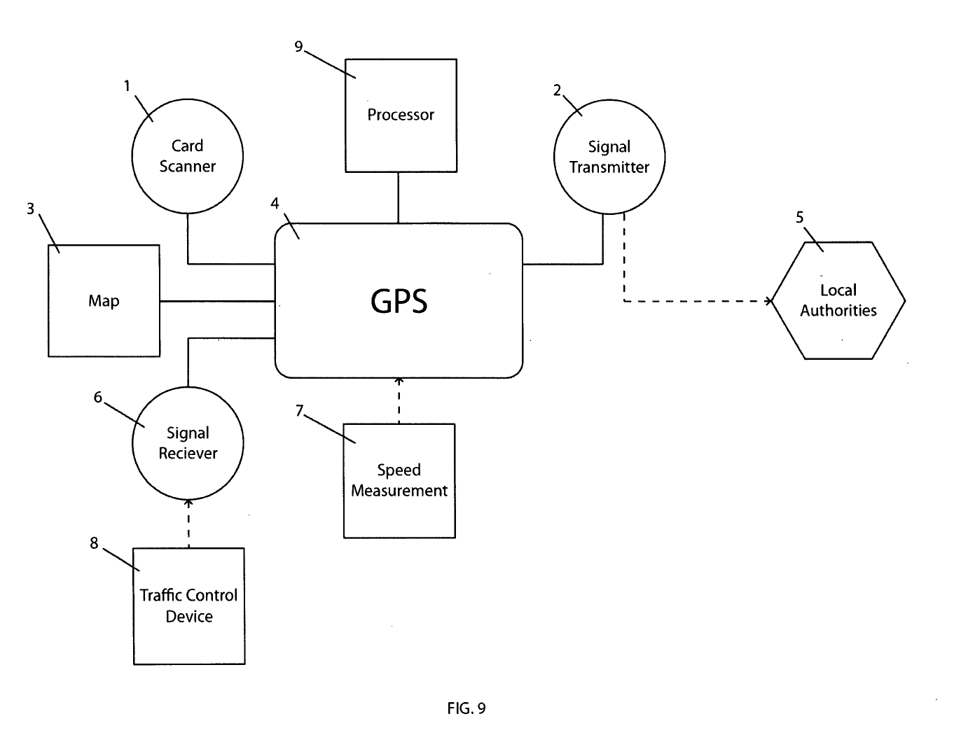

The police with you referred to as “PWY” herein is a device that is in the form of a modified GPS system 4 as showing in FIG. 9. This device shall be installed in a vehicle's dashboard. This device shall be uniquely identified by a serial number referred to as “S-number” herein. The S-number will be registered with DMV and serve as an identifier for the device and vehicle in which it is installed. The S-number can be the VIN of the subject vehicle or s-number of the device. The PWY shall be installed in all existing & new vehicles. When registering your vehicle, the DMV shall register the s-number of the device with all pertinent information from the owner of the vehicle. If anyone tried disconnecting the device the police department shall receive a signal and the car owner shall receive a ticket and the car will not start.

The PWY system shall have a GPS 4 (see drawing 3/3 FIG. 9) which shall be a standard GPS with additional capabilities. The additional capabilities must include derivation of direction of travel, derivation of speed of travel, voice and visual indication of textual information. The GPS4 shall also be capable of storing location points for traffic control devices. The precision of the GPS 4 shall be such that any traffic violation based on location shall be identified.

The PWY shall have a processor 9 (see 3/3 FIG. 9) which shall process the speed input from the speed measurement input 7 and check that speed against the derived speed from the GPS 4 location changes. The processor 9 shall also be programmed in such a way, based on the map 3 data points and the behavior of the driver, the device can identify if a traffic law has been violated. Additional data shall be provided via the receiver 6 and traffic control devices 8 for purposes of identifying changing elements on the road that cannot be identified through location alone.

The PWY shall have an identification card scanner 1 (see FIG. 9) which shall provide means for the processor 9 to read a drivers license. The information of the driver shall be posted on the GPS 4 screen, and that specific person shall be liable for the activities of the car for that session. The car shall not to be allowed to start until a valid driver's license has been read by the scanner 1. The transmitter 2 shall send signal to the local authority 5 with information such as name, ID number, s-number, and request to start signal. The local authority 5 will check the validation of driver license and respond back with either authorized or denied response.

Traffic control devices shall be equipped with transmitters to send signal to the receiver 6 of the PWY system. The signal shall contain a code that represents the state of that traffic control device and the traffic law enforced. These devices shall be installed on all above head signs. An example is of a traffic light with three colors; red, yellow, green. The traffic control device shall broadcast its current state directionally and to a lengthy enough area applicable for the purposes of the traffic control device. This information shall allow the PWY to determine if a traffic violation has occurred such a running a red light. If the vehicle moved through the area of the entire area of the signal while the signal stated the light was red it would indicate that the driver had not stopped for the signal.

The PWY system shall inform the operator of the vehicle if they are in the process of violating a traffic law. The indication will be shown on the GPS 4 screen and there will be an audio indicator telling the driver that a ticket has been issued. If the traffic violation is a speeding violation the PWY will warn the driver that they have surpassed the speed limit and give them a short period of time in which to slow down. If the period of time has elapsed and the vehicle has not slowed to the limit a ticket will be issued. This issuance will be indicated on the GPS 4 screen as well as have an audio indicator. The PWY system shall indicate the type of violation along with the date and time of issuance.

The PWY system transmitter 2 shall send signal to the local authority when a traffic violation has occurred. The signal sent shall include the S-number of the PWY system, traffic violation code, and time and date of violation. When the traffic authority responds with indication that they have received the signal the PWY system shall indicate to the operator of the vehicle that a traffic ticket has been issued.

The PWY map 3 will be loaded with zones such as shown in FIG. 2 These zones will be for traffic violations including but not limited to areas such as speed areas, parking areas, school zone, and lane changing zones. The PWY map 3 will also be loaded with locations of traffic control devices 8 including but not limited to stop signs, no turn on red signs, yield signs, and no left turn signs. This map may be updated via the receiver 6 by the local authority 5.

The invention is useful for monitoring and regulating the behavior of drivers and transmitting any such monitored behavior to the local authority based on law established for such purposes.

What is claimed is:

1. A navigation apparatus comprising:
A traffic control device obtaining receiver for obtaining information regarding the current state of the transmitting traffic control device for purposes of detecting traffic violations.
A controller for determining whether a predetermined condition has occurred and therefore an operator of the vehicle has committed a traffic violation.
A transmitter to transmit traffic violation data to the local authorities.
